(19) United States
(12) Patent Application Publication
(10) Pub. No.: US 2010/0025481 A1
(43) Pub. Date: Feb. 4, 2010

(54) METHOD FOR PRODUCING AN APPARATUS FOR WIRELESS COMMUNICATION OR FOR PRODUCING A PRELAMINATE FOR SUCH AN APPARATUS

(75) Inventors: VOLKER BROD, Bad Abbach (DE); HANS-PETER MONSER, Dresden (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: MÜHLBAUER AG, Roding (DE)

(21) Appl. No.: 12/510,723

(22) Filed: Jul. 28, 2009

(30) Foreign Application Priority Data
Jul. 30, 2008 (DE) 10 2008 035 522.4

(51) Int. Cl. H01Q 1/38; G06K 19/067; B44C 3/00

(52) U.S. Cl. 235/492; 343/700 MS; 156/239

(57) ABSTRACT

In a method for producing an apparatus for wireless communication, particularly a contactless card, a E-passport, a Smart label or the like, or for producing a prelaminate for such an apparatus, an antenna is produced by applying an antenna structure to a substrate using an additive method, such as metal deposition. The substrate can be made of a PVC or polycarbonate material. A transponder is then produced by connecting a bare chip to the antenna using a direct assembly process, such as a flip-chip process. In a next step, the apparatus or the prelaminate for the apparatus is produced by connecting the transponder to further layers using a laminating method, wherein at least one of the further layers in directly adjoining relationship to the substrate is made of a same material as the substrate.

### CROSS-REFERENCES TO RELATED APPLICATIONS

This application claims the priority of German Patent Application, Serial No. 10 2008 035 522.4, filed Jul. 30, 2008, pursuant to 35 U.S.C. 119(a)-(d), the content of which is incorporated herein by reference in its entirety as if fully set forth herein.

### BACKGROUND OF THE INVENTION

The present invention relates to a method for producing an apparatus for wireless communication, particularly a contactless card, an E-passport, a Smart label or the like, or for producing a prelaminate for such an apparatus. Furthermore, the invention relates to a prelaminate and an apparatus for wireless communication.

The following discussion of related art is provided to assist the reader in understanding the advantages of the invention, and is not to be construed as an admission that this related art is prior art to this invention.

To date, wireless communication among the aforementioned products usually takes place using RFID (Radio Frequency Identification) technology, so that reference is subsequently also made to RFID chips, without this being intended to be understood to be a restriction. Applications with RFID functionality in contactless plastic cards are becoming increasingly significant worldwide. It is often desirable for such RFID products to have, beside the RFID functionality, that is to say the possibility of using a contactless RFID interface to interchange data with the RFID chip and storing it in a memory integrated in the RFID product, to have additional, usually application-specific, functionalities. By way of example, chip cards will be provided with a photo of the card owner on the card surface or will be equipped with security features, such as holograms, laser engravings or the like.

These requirements give rise to certain guidelines for these RFID products regarding the design of and the production process for such RFID products.

Apparatuses for wireless communication, particularly contactless cards, E-passports, Smart labels or the like, are usually constructed from a multiplicity of layers. These layers are normally made of plastic materials and are connected to one another using a laminating technique. The individual layers are welded together, suitably under pressure using heatable laminating rollers and/or laminating presses.

Apparatuses for wireless communication have at least a semiconductor chip (chip), i.e. an electronic component having at least one integrated electronic circuit, and an antenna coil (antenna) connected to the chip. In this case, the antenna is designed to match the selected chip and on the basis of the RFID technology used (RFID or UHF). The chip may be a bare chip (bare die) or a packaged chip (chip module). Depending on the application, an RFID chip with or without securing features, with a large or small data store and with an RF or UHF interface is used. The chip and the antenna form a transponder and are usually situated on a common substrate, the transponder layer, which is also referred to as the “inlay” or “inlet”.

Frequently, the transponder layer is processed together with further layers, such as compensation layers, base and top layers, etc., using a lamination process to form a layer composite, referred to as “prelaminate”. The prelaminate as an intermediate product can then be processed in further method steps to form a contactless chip card, an E-passport, a Smart label or the like. Alternatively, direct production of these products without a prelaminate is possible.

To produce the transponder layer for a prelaminate or an apparatus for wireless communication, the antenna structures are normally first applied to a plastic substrate. The chip is then assembled. Various methods are known for producing the antenna as well as for the chip assembly.

Bare chips are usually assembled using direct assembly techniques, which involve the bare chips being applied to the substrate directly from the wafer. An example of a direct assembly technique involves flip-chip technique in which the bare chips are assembled with the active side toward the substrate and simultaneously electrically contacted by means of plastic bumps. The adhesive bonds produced in this assembly method are used both for mechanically fixing the chips on the substrate and for producing electrical contact between the contact connections of the chip, on the one hand, and the connections of the antenna which is already on the substrate, on the other hand. The anisotropic adhesives used require curing times of several seconds at comparatively high temperatures (approximately 150° C.-200° C.). In the case of substrates made of materials with a low melting temperature, for example polyvinyl chloride (PVC) with a melting temperature of approximately 80° C., there is therefore the risk of irreversible deformation of the substrate. For flip-chip assembly of bare chips, the substrate is therefore usually made of a polyethylene terephthalate film (PET film) temperature-stabilized to approximately 200° C.

The antenna is produced on PET film usually using subtractive methods. Normally, the antenna structures are applied by means of local chemical removal of a copper or aluminum foil bonded to the substrate, for example by means of etching with sulphuric acid.

A fundamental quality criterion for the lamination is the adhesive strength of the layers. The best adhesive strength is achieved when the layers to be laminated are made of identical plastic materials. In the event, the other layers of a prelaminate or of a contactless chip card or the like are thus made of a PVC material, which is generally the case of conventional products, the PET antenna substrate can be laminated only using a special hotmelt adhesive film (HAF film, “heat-sealable adhesive film”) introduced between the PET inlet and the adjacent PVC layers or only if the PET film is coated with PVC material prior to lamination. This method is very complex and comparatively error-prone.

When the other layers are made of a polycarbonate material, lamination is not possible at all with a PET antenna substrate because of lack of adhesive strength between the layers made of different materials. This is disadvantageous, since it is often particularly desirable to use polycarbonate material. For example, the application of certain high-quality security features, such as provision of a picture of the card owner in order to personalize the card by means of laser, is especially simple, when polycarbonate material is used.

Even if one were to contemplate the use of polycarbonate as material for the antenna substrate, which is impossible in the flip-chip process in view of the high temperatures for curing the adhesive, the etching technique used would render it impossible to achieve a stable connection between the polycarbonate substrate and an adjacent polycarbonate layer, because the afore-described etching process leaves behind residues between the antenna structures from the adhesive which has been required for attaching the copper foil to the substrate. These adhesive residues usually prevent a stable connection for the later lamination.

It would therefore be desirable and advantageous to address prior art shortcomings and to provide an improved method for producing particularly high-quality prelaminates and contactless chip cards, E-passports or the like.

### SUMMARY OF THE INVENTION

According to one aspect of the present invention, a method includes the steps of applying an antenna structure to a substrate using an additive process to produce an antenna, with the substrate being made of a PVC or polycarbonate material, connecting a bare chip to the antenna by means of direct assembly to produce a transponder, and applying further layers upon the transponder using a laminating process, with at least one of the further layers in directly adjoining relationship to the substrate being made of a material which is the same as the material of the substrate, thereby producing an apparatus for wireless communication or a prelaminate for the apparatus.

According to another advantageous feature of the present invention, the additive process may include metal deposition.

A particular benefit of the present invention is its application for the production of layered products made of plastic, particularly made of PVC or polycarbonate, with RFID functionality. By way of example, but not exclusively, this relates to contactless chip cards, including chip cards with an identification function, chip cards with a payment function and the like, E-passports, Smart labels etc. The present invention relates exclusively to the use of bare chips in this context. For this, it is possible to use various antenna types, for example with RF and UHF antennas (13.56 MHz and 860-960 MHz, respectively).

A basic idea of the present invention is the use of a same material for the antenna substrate as for the rest of the product environment, namely PVC or polycarbonate, in order to achieve optimum adhesive strength for the layers following the lamination process. This can be realized in accordance with the present invention by using additive technology for producing the antenna. When the bare RFID chips are assembled using flip-chip technique, adhesives with low curing temperatures can be used. In this case, the curing temperatures can be selected so low as to match the substrate properties, inter alia, that the substrate material (in this case polycarbonate or PVC) is not inadmissibly softened during the flip-chip assembly process, on the one hand, but sufficient curing of the adhesive is ensured on the other hand.

The additive technique used involves the application of the antenna structure onto the substrate, i.e. to a layer printed on the substrate. Currently preferred is the application of the antenna structure by depositing antenna material, typically copper. Alternative methods for the additive technique are applying the electrically conductive antenna material to the substrate by means of currentless deposition (electroless plating), coating, particularly plasma coating, sputtering, vapor deposition and dusting. In comparison with other methods, the additive technique is distinguished by comparatively simple handling.

Depending on which additive method is employed, and whether RF or UHF technology is involved, the antenna applied to the substrate can be produced in different layer thicknesses.

The use of additive antenna technology ensures high-quality lamination of the layers of prelaminate or end product. This is achieved particularly by virtue of the antenna structure being applied to the substrate in a manner such that the surface of the substrate apart from the applied antenna structure is exposed. This prevents soiling of the plastic surface by adhesive residues or the like. In other words, antenna material (for example copper) is applied—in contrast to the etching technique—only to those areas where an antenna structure is actually provided.

The present invention provides—particularly for the use of additive antenna technology—a production method for prelaminates or apparatuses for wireless communication which is particularly well suited to the assembly of bare chips. The transponder is therefore produced by means of direct assembly of a bare RFID chip (direct chip attach). Currently preferred is the use of a flip-chip process. Of course, other direct assembly methods may equally be applicable.

While the afore-stated applications permitted to date a lamination with layers of the same material only when using “wire-laying technique” and exclusively for packaged chips, so-called chip modules, the present invention allows, for the first time, the use of a direct assembly method in order to integrate bare chips in a lamination product made of layers of the same material. This makes the production method for such products and corresponding prelaminates much faster and more productive in comparison with wire-laying technique.

Advantageously, the method according to the present invention can, in principle, also be used for chip modules. In other words, the invention can be used across technologies.

The production of antennas on a substrate made of PVC or polycarbonate using an additive technique is also beneficial because of the flexibility that can be achieved. Thus, the geometry or electrical properties (such as reading range) of the antennas can be matched to the requirements at hand. For example, antennas produced in two layers, i.e. arranged on opposite sides of the plastic substrate, can help to save space.

According to another aspect of the present invention, a prelaminate for an apparatus for wireless communication includes a transponder having an antenna, which is formed from a substrate made of a PVC or polycarbonate material and an antenna structure applied on the substrate by an additive process, and a chip connected to the antenna, and plural layers connected to the transponder by a laminating process, wherein at least one of the layers in directly adjoining relationship to the substrate is made of a material which is the same as the material of the substrate.

According to yet another aspect of the present invention, an apparatus for wireless communication, particularly a contactless card, E-passport, or Smart label, includes a transponder having an antenna, which is formed from a substrate made of a PVC or polycarbonate material and an antenna structure applied on the substrate by an additive process, and a chip connected to the antenna, and plural layers connected to the transponder by a laminating process, wherein at least one of the layers in directly adjoining relationship to the substrate is made of a material which is the same as the material of the substrate.

It will be understood by persons skilled in the art that the apparatus involved here for wireless communication are not limited to chip cards or the like. For example, the apparatus may have not only a semiconductor chip but also a battery or another electronic component or a display, an input apparatus, etc. Typical examples of such apparatuses are multifunction cards with a display for reading off information or cards with batteries for active circuits, such as sensors, etc.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic sectional illustration of an antenna substrate with applied antenna;

FIG. 2 is a schematic sectional illustration of a transponder,

FIG. 3 is a schematic sectional illustration of a finished prelaminate.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

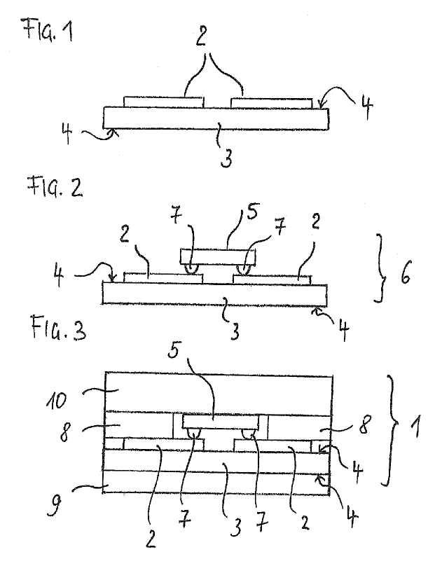

Turning now to the drawing, and in particular to FIG. 1, there is shown a schematic sectional illustration of an antenna substrate with applied antenna 2. To produce a prelaminate 1, the antenna 2 is first produced by applying an antenna structure onto the substrate 3 using an additive process, suitably any conventional coating process. A layer is hereby printed onto the substrate 3 in accordance with the later antenna structure, and copper is then deposited on the layer in a subsequent step. Copper is hereby applied only to those areas on the substrate 3 where an antenna structure is actually provided. The remainder of the surface 4 of the substrate 3 remains exposed. The substrate 3 is a polycarbonate substrate which is present as a film.

In a subsequent process step, as shown in FIG. 2, a transponder 6 is produced by applying a bare RFID chip 5 to the antenna 2 using a flip-chip technique. As a consequence of the use of the polycarbonate substrate 2, the technique used here differs from conventional flip-chip processes in that an adhesive 7 is used which cures at a process temperature below 130° C. during a reaction time of preferably approximately 8 to 15 seconds. As a result, the polycarbonate film material softens. For this reason, the RFID chip 5 is cured with very small bonding forces (approximately 0.5-1N) and thereby connected to the antenna 2.

Next, as shown in FIG. 3, a lamination process known per se is used to produce the prelaminate 1 by applying further layers such as a compensation layer 8, a base layer 9, and a top layer 10 which are all made of the same polycarbonate material as the still exposed antenna substrate surface 4, so that it is possible to achieve very good adhesive strength for the layers. The compensation layer 8 compensates hereby for the component height of the RFID chip 5 in the structure of the prelaminate 1 so that the body of the prelaminate 1 does not become uneven in the area where the RFID chip 5 is situated, when the entire layer composite is laminated.

The same method can also be used to produce a prelaminate 1 in which the antenna substrate and the rest of the layers are made of the PVC material.

The prelaminate 1 can then be processed further in further method steps to form a complete RFID product, for example a contactless chip card.

The method steps outlined above are also performed when it is not a prelaminate 1 but rather a complete RFID product which is being produced directly, i.e. without the intermediate product that is the prelaminate 1. By way of example, the type and number of layers to be laminated then change. As an example, it is possible for printed and/or transparent films to be inserted between the compensation layer 8 and the top layer 10, on the one hand, and between the substrate 3 and the base layer 9, on the other hand.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method, comprising the steps of:
applying an antenna structure to a substrate using an additive process to produce an antenna, with the substrate being made of a PVC or polycarbonate material;
connecting a bare chip to the antenna by means of direct assembly to produce a transponder; and
applying further layers upon the transponder using a laminating process, with at least one of the further layers in directly adjoining relationship to the substrate being made of a material which is the same as the material of the substrate, thereby producing an apparatus for wireless communication or a prelaminate for said apparatus.

2. The method of claim 1, wherein the additive process includes metal deposition.

3. The method of claim 1, wherein the direct assembly includes a flip-chip process.

4. The method of claim 1 for producing a contactless card, an E-passport, or a Smart label.

5. The method of claim 1, wherein the antenna structure is applied to the substrate such that a surface of the substrate apart from the applied antenna structure remains exposed.

6. The method of claim 3, wherein the flip-chip process is executed at a process temperature which is does not exceed 130° C.

7. The method of claim 3, wherein the chip is cured applying bonding forces below 1N during the flip-chip process.

8. The method of claim 1, wherein all the further layers are made of a material which is the same as the material of the substrate.

9. The method of claim 1, wherein the chip is an RFID chip.

10. The method of claim 1, wherein the antenna is an HF or UHF antenna.

11. A prelaminate for an apparatus for wireless communication, comprising:
a transponder having
an antenna, which is formed from a substrate made of a PVC or polycarbonate material and an antenna structure applied on the substrate by an additive process, and
a chip connected to the antenna; and
plural layers connected to the transponder by a laminating process, wherein at least one of the layers in directly adjoining relationship to the substrate is made of a material which is the same as the material of the substrate.

12. The prelaminate of claim 11, wherein the additive process includes metal deposition.

13. The prelaminate of claim 11, wherein the apparatus is a contactless card, an E-passport, or a Smart label.

14. Apparatus for wireless communication, produced using a prelaminate of claim 11.

15. Apparatus for wireless communication, particularly a contactless card, E-passport, or Smart label, comprising:
a transponder having
an antenna, which is formed from a substrate made of a PVC or polycarbonate material and an antenna structure applied on the substrate by an additive process, and
a chip connected to the antenna; and
plural layers connected to the transponder by a laminating process, wherein at least one of the layers in directly adjoining relationship to the substrate is made of a material which is the same as the material of the substrate.

16. The prelaminate of claim 15, wherein the additive process includes metal deposition.
